(19) United States
(12) Patent Application Publication
(10) Pub. No.: US 2016/0002080 A1
(43) Pub. Date: Jan. 7, 2016

(54) WATER PURIFICATION SYSTEM FOR HARD BOTTOM LANDSCAPE WATER BODY

(71) Applicant: Dongguan Vanke Building Technique Research Co., Ltd, Dongguan (CN)

(72) Inventors: Yun Wang, Dongguan (CN); Yu Shi, Dongguan (CN); Pengge Xi, Dongguan (CN); Shengbin Zhang, Dongguan (CN)

(73) Assignee: Dongguan Vanke Building Technique Research Co., Ltd

(21) Appl. No.: 14/791,260

(22) Filed: Jul. 3, 2015

(30) Foreign Application Priority Data
Jul. 3, 2014 (CN) 201410318296.1

(51) Int. Cl. C02F 3/10

(52) U.S. Cl. CPC C02F 3/101; C02F 3/104; C02F 2003/001

(57) ABSTRACT

A water purification system for a hard bottom landscape water body is provided, with a bottom of the hard bottom landscape water body paved with hard materials, comprising a filling element layer and a frame body, wherein the frame body is paved on the bottom of the landscape water body; the frame body includes a cover plate with a plurality of through-holes, and a plurality of supporting parts positioned below the cover plate; the filling element layer includes a plurality of filling elements disposed between the plurality of supporting parts positioned below the cover plate, and the filling elements further include structures configured for microorganisms in water to adhere to. In the present application, the filling element layer provides an adhesion medium for the microorganisms in water, and the frame body provides a protection to the filling element layer, which creates an advantageous site for the microorganisms in water.

### CROSS-REFERENCE TO RELATED APPLICATIONS

This present application claims the benefit of Chinese Patent Application No. 201410318296.1 filed on Jul. 3, 2014, the contents of which are hereby incorporated by reference.

### TECHNICAL FIELD

The present application relates to the technical field of landscape water body treatment, and more particularly, relates to a water purification system for a hard bottom landscape water body.

### BACKGROUND

With the increase of requirements for the live environment, a growing number of landscape water bodies are arranged in public such as living quarters in city, parks, or the like. However, most of the landscape water bodies in the prior art include dead water which is closed and stagnant, and a self purification capacity of the water bodies is poor, and the water bodies are vulnerable to pollution. In severe cases, it is possible to lead to eutrophication in the water bodies. Besides, algas in still water is prone to be overgrown, such that the water body is getting black and smelly. At present, purification methods for the landscape water body mainly include physics methods (such as circulating filtration, drop-aeration or the like), chemical methods (such as directly chemical dosing, air floatation or the like), biological methods (such as biology floating island, planting aquatic organisms, bacteria-throwing, or the like), and ecological methods (such as building an ecosystem).

In the physics methods, filtering methods are mainly used, which are energy-efficient and environmental protected water treatment methods. The advantages of the physics methods lie in that, the methods take effect quickly and have a short running cycle, which are very suitable for little water bodies. However, in a water purification system using the filtering method, a plurality of impurities in water such as algas are attached to filtering layers after the filtering layers has been used for a long time, and thus an infiltration effect may be affected. Besides, water to be purified needs to be cycled repeatedly before it becomes clear, which is high power-consumed. In addition, the algas, organic pollutants or the like in water can not be effectively removed by means of the physics methods.

For the chemical methods, chemical reagents are usually added into the water. The chemical methods have the advantages of taking effect quickly. However, a secondary pollution may be easily caused by means of the chemical methods, which has a considerable impact on the environment. Besides, the economic cost of the chemical methods is high, and the chemical reagents need to be continuously added into the water. Once stops adding the chemical reagents, the water quality can not be guaranteed.

In the biological methods, it is necessary to introduce plenty of biological species and floras. In this way, the water body forms an ecosystem, and harmful substances in water may be eliminated by the organisms. The biological methods are substantially harmless to the environment, and the energy consumption thereof is low, in such a way that a sustainable development may be truly realized. However, the engineering of a traditional biological method is complicated, highly technical and difficult, and needs a professional team to accomplish.

The ecological methods are comprehensive biological methods, which are strict with the types of the water body. And technical requirements at an operation stage are also very high.

### BRIEF SUMMARY

The object of the present application is to provide a water purification system for a hard bottom landscape water body, aiming at the defects described above that the purification effect is poor, a secondary pollution is easily caused, and the engineering is complicated.

The technical solutions to solve the technical problem are as follows.

In one aspect, a water purification system for a hard bottom landscape water body is provided, and the bottom of the landscape water body paved with hard materials, comprising: a filling element layer and a frame body, wherein the frame body is paved on the bottom of the landscape water body; the frame body includes a cover plate with a plurality of through-holes, and a plurality of supporting parts positioned below the cover plate; the filling element layer includes a plurality of filling elements disposed between the plurality of supporting parts positioned below the cover plate, and the filling elements further include structures configured for microorganisms in water to adhere to.

In one embodiment, the water purification system further includes a pebble layer formed by a plurality of individual pebbles paved on an upper surface of the cover plate of the frame body.

In one embodiment, the water purification system further includes a flow pushing device for pushing the flow of the water body, and a flow pushing nozzle of the flow pushing device is positioned above the pebble layer.

In one embodiment, each of the filling elements is made from an elastic material, and includes a plurality of tentacles distributed radially.

In one embodiment, the filling element layer includes a plurality of filling element groups, and each of the filling element groups includes a plurality of filling elements connected into a string.

In one embodiment, the plurality of the filling element groups of the filling element layer are parallel to each other.

In one embodiment, the supporting part of the frame body includes a plurality of supporting legs and a plurality of baffles connected between two adjacent supporting legs; a plurality of grids are formed under the cover plate by the baffles enclosed together, and the filling elements are distributed into the grids.

In one embodiment, the cover plate is hollowed out as a whole, and has a structure of a planar in shape of a screen mesh; a reinforcing rib is provided between every two support legs opposite to each other.

In one embodiment, a height of the supporting leg ranges from 3 cm to 8 cm, and a distance between two adjacent supporting legs ranges from 3 cm to 5 cm.

In one embodiment, the pebble layer includes a plurality of pebbles independent of each other, and a mean diameter of the pebbles ranges from 3 cm to 8 cm.

In the water purification system for a hard bottom landscape water body according to the present application, the filling element layer provides an adhesion medium for the microorganisms in water, and the frame body further provides a protection to the filling element layer. In this way, the water purification system for a hard bottom landscape water body creates an advantageous site for the survival and enrichment of the microorganisms in water, and finally improves a purification effect of the landscape water body. The present application further adds a flow pushing device to create an oxygen-enriched and substances cycling environment for the microorganisms in water for the growth and reproduction thereof, and further improves a survival rate of the microorganisms in water.

### BRIEF DESCRIPTION OF THE DRAWINGS

FIG. 1 illustrates a schematic view of a water purification system for a hard bottom landscape water body according to an embodiment of the present application;

FIG. 2 is a plan view of the water purification system for a hard bottom landscape water body shown in FIG. 1;

FIG. 3 illustrates a schematic view of a frame body shown in FIG. 1; and

FIG. 4 illustrates a schematic view of a filling element shown in FIG. 1.

### DETAILED DESCRIPTION OF THE PREFERRED EMBODIMENT

To make the object, the technical solution and the technical advantages more clearly, the present application will be further described with reference to the accompanying drawings and embodiments in the following. It should be understood that, the specific embodiment described here is just for explanation, not for limitation.

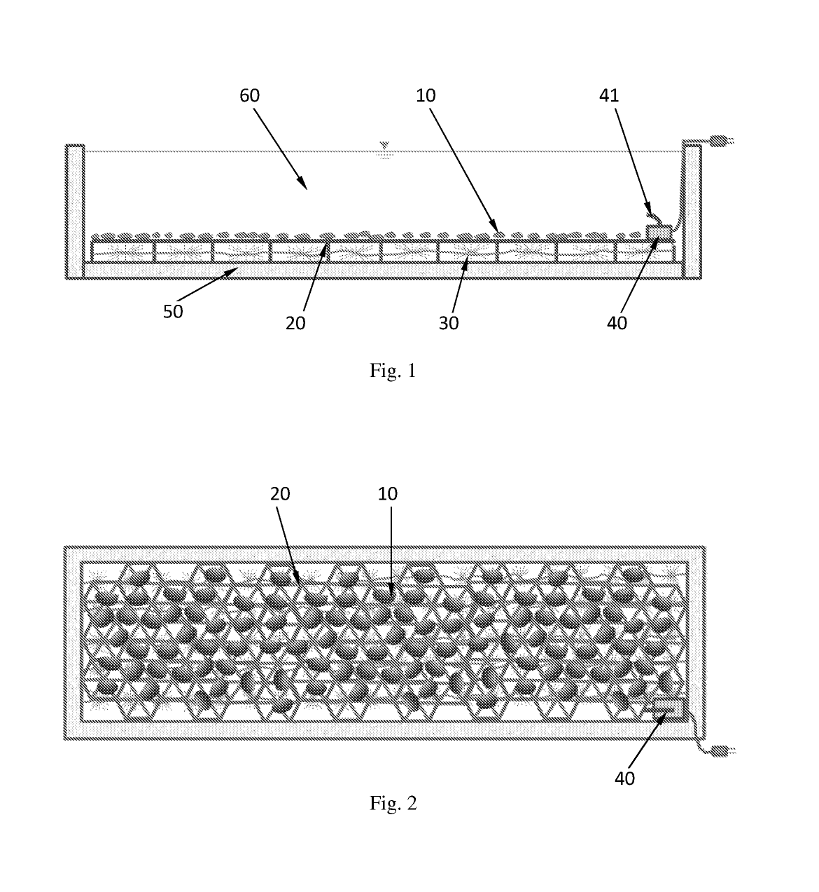

FIGS. 1-4 show a water purification system for a hard bottom landscape water body according to the present application. In this case, a bottom 50 of the hard bottom landscape water body 60 is paved with hard materials (such as cement, dalle, or the like). The system includes a filling element layer 30 and a frame body 20. In this case, the frame body 20 is paved on a surface of the bottom 50 of the landscape water body, wherein the frame body 20 includes a cover plate 21 with a plurality of through-holes, and a plurality of supporting parts positioned below the cover plate 21. The filling element layer 30 includes a plurality of filling elements 31 disposed between the plurality of supporting parts positioned below the cover plate 21, and the filling elements 31 further include structures configured for microorganisms in water to adhere thereto.

In the water purification system for a hard bottom landscape water body described above, the filling element 31 of the filling element layer 30 provides an adhesion medium for the microorganisms in water, and the frame body 20 further provides a protection to the filling element layer 30. In this way, the water purification system for a hard bottom landscape water body creates an advantageous site for the survival and enrichment of the microorganisms in water, and thus it is possible to improve a survival rate of the microorganisms in water for purifying the water quality, and finally improve a purification effect of the landscape water body.

In order to make the landscape water body 60 more beautiful, and to prevent the frame body 20 from floating (for example, when the frame body 20 is made from materials with a less density), a pebble layer 10 is further added onto the cover plate 21 of the frame body 20. In this case, the pebble layer 10 is formed by a plurality of individual pebbles paved on an upper surface of the cover plate 21 of the frame body 20. In particular, the pebble layer 10 may be paved with a plurality of pebbles with a mean diameter ranging from 3 cm to 8 cm (a mean diameter of about 5 cm is preferred, in which case the landscape water body not only is more beautiful, but also has a larger surface area which is advantageous for the proliferation of the microorganisms).

In order to achieve a flow of the water body in the landscape water body 60 and to further improve the aeration (the aeration is configured to increase dissolved oxygen in the water body to improve the survival rate of the microorganisms), a flow pushing device 40 for pushing the flow of the water body is further provided in the water purification system for a hard bottom landscape water body. In this case, a low-energy device may be employed as the flow pushing device 40, and the flow pushing device 40 is further disposed on the upper surface of the cover plate 21 of the frame body 20. A flow pushing nozzle 41 of the flow pushing device 40 is positioned above the pebble layer 10. Certainly, it is possible to arrange a plurality of flow pushing devices 40 in different positions on the cover plate 21, if the landscape water body is relative large. Particularly, the flow pushing device 40 may be activated when the water quality is poor.

As shown in FIG. 4, each of the filling elements 31 is made from an elastic material, and includes a plurality of tentacles distributed radially. This structure may increase a surface area of the elastic materials, that is, increase an adhesion area for the microorganisms. Certainly, in practical applications, it is also possible to employ other structures for the microorganisms in water to adhere thereto as the filling element 31.

Particularly, the filling element layer 30 of the water purification system for a hard bottom landscape water body described above includes a plurality of filling element groups, and each of the filling element groups includes a plurality of filling elements 31 connected into a string. In addition, the plurality of the filling element groups of the filling element layer 30 are parallel to each other. With the structure described above, it is convenient for the filling elements 31 of the filling element layer 30 to be arranged evenly on the bottom 50 of the landscape water body 60, and for the maintaining of the filling element layer 30.

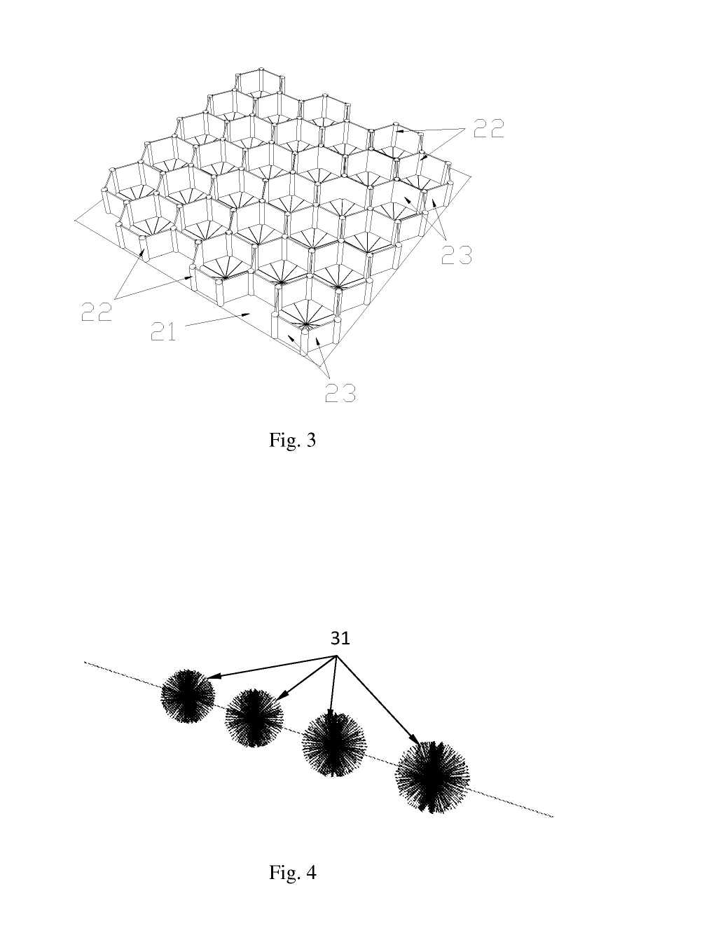

FIG. 3 is a schematic view of the frame body 20. In this case, the supporting part of the frame body 20 may include a plurality of supporting legs 22 and a plurality of baffles connected between two adjacent supporting legs 22. In this case, one end of each of the supporting legs 22 is connected to a lower surface of the cover plate 21, and the other end of each of the supporting legs 22 is supported on the bottom 50 of the landscape water body 60. A plurality of grids are formed under the cover plate 21 by the baffles 23 enclosed together, and the filling elements 31 are distributed into the grids such that the filling elements 31 are avoided from displacing along with the flow of the water body.

Particularly, in order to make the engineering operability greater, the cover plate 21 is hollowed out as a whole, that is, the whole cover plate 21 has a structure of a planar in shape of a screen mesh, and a reinforcing rib is provided between every two support legs opposite to each other, as shown in FIG. 2.

A height of the supporting leg 22 ranges from 3 cm to 8 cm (preferably, about 5 cm), that is, a distance between the cover plate 21 and the bottom 50 of the landscape water body ranges from 3 cm to 8 cm. A distance between two adjacent supporting legs 22 ranges from 3 cm to 5 cm. In this way, there is enough space for the filling element layer 31.

Though the present application is explained with reference to the specific embodiments, however, it should be understand that in the inspiration of the present application, one skilled in the art may make many modifications or equivalent replacement, without going beyond the purpose and the scope the claims intend to protect of the present application. Therefore, all these belong to the protection scope of the present application should be protected.

1. A water purification system for a hard bottom landscape water body, with a bottom paved with hard materials, comprising: a filling element layer and a frame body, wherein the frame body is paved on the bottom of the landscape water body; the frame body includes a cover plate with a plurality of through-holes, and a plurality of supporting parts positioned below the cover plate; the filling element layer includes a plurality of filling elements disposed between the plurality of supporting parts positioned below the cover plate, and the filling elements further include structures configured for microorganisms in water to adhere to.

2. The water purification system for a hard bottom landscape water body according to claim 1, wherein the water purification system further includes a pebble layer formed by a plurality of individual pebbles paved on an upper surface of the cover plate of the frame body.

3. The water purification system for a hard bottom landscape water body according to claim 1, wherein the water purification system further includes a flow pushing device for pushing the flow of the water body, and a flow pushing nozzle of the flow pushing device is positioned above the pebble layer.

4. The water purification system for a hard bottom landscape water body according to claim 2, wherein the water purification system further includes a flow pushing device for pushing the flow of the water body, and a flow pushing nozzle of the flow pushing device is positioned above the pebble layer.

5. The water purification system for a hard bottom landscape water body according to claim 1, wherein each of the filling elements is made from an elastic material, and includes a plurality of tentacles distributed radially.

6. The water purification system for a hard bottom landscape water body according to claim 2, wherein each of the filling elements is made from an elastic material, and includes a plurality of tentacles distributed radially.

7. The water purification system for a hard bottom landscape water body according to claim 1, wherein the filling element layer includes a plurality of filling element groups, and each of the filling element groups includes a plurality of filling elements connected into a string.

8. The water purification system for a hard bottom landscape water body according to claim 7, wherein the plurality of the filling element groups of the filling element layer are parallel to each other.

9. The water purification system for a hard bottom landscape water body according to claim 2, wherein the filling element layer includes a plurality of filling element groups, and each of the filling element groups includes a plurality of filling elements connected into a string.

10. The water purification system for a hard bottom landscape water body according to claim 9, wherein the plurality of the filling element groups of the filling element layer are parallel to each other.

11. The water purification system for a hard bottom landscape water body according to claim 1, wherein the supporting part of the frame body includes a plurality of supporting legs and a plurality of baffles connected between two adjacent supporting legs; a plurality of grids are formed under the cover plate by the baffles enclosed together, and the filling elements are distributed into the grids.

12. The water purification system for a hard bottom landscape water body according to claim 2, wherein the supporting part of the frame body includes a plurality of supporting legs and a plurality of baffles connected between two adjacent supporting legs; a plurality of grids are formed under the cover plate by the baffles enclosed together, and the filling elements are distributed into the grids.

13. The water purification system for a hard bottom landscape water body according to claim 1, wherein the cover plate is hollowed out as a whole, and has a structure of a planar in shape of a screen mesh; a reinforcing rib is provided between every two support legs opposite to each other.

14. The water purification system for a hard bottom landscape water body according to claim 2, wherein the cover plate is hollowed out as a whole, and has a structure of a planar in shape of a screen mesh; a reinforcing rib is provided between every two support legs opposite to each other.

15. The water purification system for a hard bottom landscape water body according to claim 1, wherein a height of the supporting leg ranges from 3 cm to 8 cm, and a distance between two adjacent supporting legs ranges from 3 cm to 5 cm.

16. The water purification system for a hard bottom landscape water body according to claim 2, wherein a height of the supporting leg ranges from 3 cm to 8 cm, and a distance between two adjacent supporting legs ranges from 3 cm to 5 cm.

17. The water purification system for a hard bottom landscape water body according to claim 1, wherein the pebble layer includes a plurality of pebbles independent of each other, and a mean diameter of the pebbles ranges from 3 cm to 8 cm.

18. The water purification system for a hard bottom landscape water body according to claim 2, wherein the pebble layer includes a plurality of pebbles independent of each other, and a mean diameter of the pebbles ranges from 3 cm to 8 cm.
